(19) United States
(12) Patent Application Publication
(10) Pub. No.: US 2026/0267309 A1
(43) Pub. Date: Sep. 10, 2026

(54) MACHINE TOOL CONTROL DEVICE

(71) Applicant: FANUC CORPORATION, Yamanashi (JP)

(72) Inventor: Shinichi TANAKA, Yamanashi (JP)

(73) Assignee: FANUC CORPORATION, Yamanashi (JP)

(21) Appl. No.: 19/491,364

(22) PCT Filed: Jul. 5, 2023
(86) PCT No.: PCT/JP2023/025028

§ 371 Date: Dec. 8, 2025

(51) Int. Cl. G05B 19/401; B23Q 11/08; F16J 15/447

(52) U.S. Cl. CPC G05B 19/401; B23Q 11/0883; F16J 15/447; G05B 2219/49108

(57) ABSTRACT

The purpose of the present invention is to provide a machine tool control device capable of limiting the consumption amount of compressed air. This machine tool control device 3 controls a machine tool M having a spindle 1 and a compressed air supply device 2 for supplying compressed air into the spindle 1, the machine tool control device 3 comprising: a rotation state information acquisition unit 311 for acquiring rotation state information indicating a rotation state of the spindle 1; a supply condition determination unit 312 for determining, on the basis of the rotation state information acquired by the rotation state information acquisition unit 311, a supply condition necessary for compressed air to be supplied to the inside of the spindle 1; and a compressed air control unit 313 for controlling the compressed air supply device 2 on the basis of the supply condition determined by the supply condition determination unit 312.

### TECHNICAL FIELD

The present disclosure relates to a machine tool control device.

### BACKGROUND ART

Conventionally, a spindle of a machine tool includes therein a bearing to support high-speed rotation. From the viewpoint of the life of the bearing, it is necessary to prevent foreign matter and foreign liquid from intruding into the interior of the spindle. However, due to the capability of the spindle to rotate at high speed, it is impractical to use a seal having a contact part. As measures to address this, there is a known technique in which a non-contact sealing structure called a labyrinth seal is provided to a spindle, and clean air is introduced into the interior of the spindle to maintain the interior at a positive pressure (air purge), thereby preventing intrusion by foreign matter and foreign liquid (Patent Document 1).

### CITATION LIST

### Patent Document

Patent Document 1: Japanese Unexamined Patent Application, Publication No. H2-100851

### DISCLOSURE OF THE INVENTION

### Problems to be Solved by the Invention

Incidentally, as the air (compressed air) to be introduced (supplied) in order to maintain the interior of the spindle at a positive pressure, compressed air is used under a preset certain supply condition. However, because different supply conditions are required for different operating conditions, there is a risk of consuming more compressed air than necessary.

It is an object of the present disclosure to provide a machine tool control device capable of reducing consumption of compressed air.

### Means for Solving the Problems

One aspect of the present disclosure relates to a machine tool control device for controlling a machine tool including a spindle and a compressed air supply device that supplies compressed air to an interior of the spindle, the machine tool control device including: a state-of-rotation information acquisition unit that acquires state-of-rotation information indicating a state of rotation of the spindle; a supply condition determination unit that determines a supply condition necessary for compressed air that is to be supplied to the interior of the spindle, based on the state-of-rotation information acquired by the state-of-rotation information acquisition unit; and a compressed air control unit that controls the compressed air supply device based on the supply condition determined by the supply condition determination unit.

### BRIEF DESCRIPTION OF THE DRAWINGS

FIG. 1 is a schematic diagram illustrating an example of surrounding of a spindle of a machine tool according to an embodiment;

FIG. 2 is a block diagram illustrating a hardware configuration of a machine tool control device according to the embodiment;

FIG. 3 is a block diagram for explaining a functional configuration of the machine tool control device according to the embodiment;

FIG. 4 is a flowchart for explaining an example of compressed air supply control by the machine tool control device according to the embodiment;

FIG. 5 is a block diagram illustrating a hardware configuration of a machine tool control device according to a modification; and

FIG. 6 is a block diagram for explaining a functional configuration of the machine tool control device according to the modification.

### PREFERRED MODE FOR CARRYING OUT THE INVENTION

### <Machine Tool>

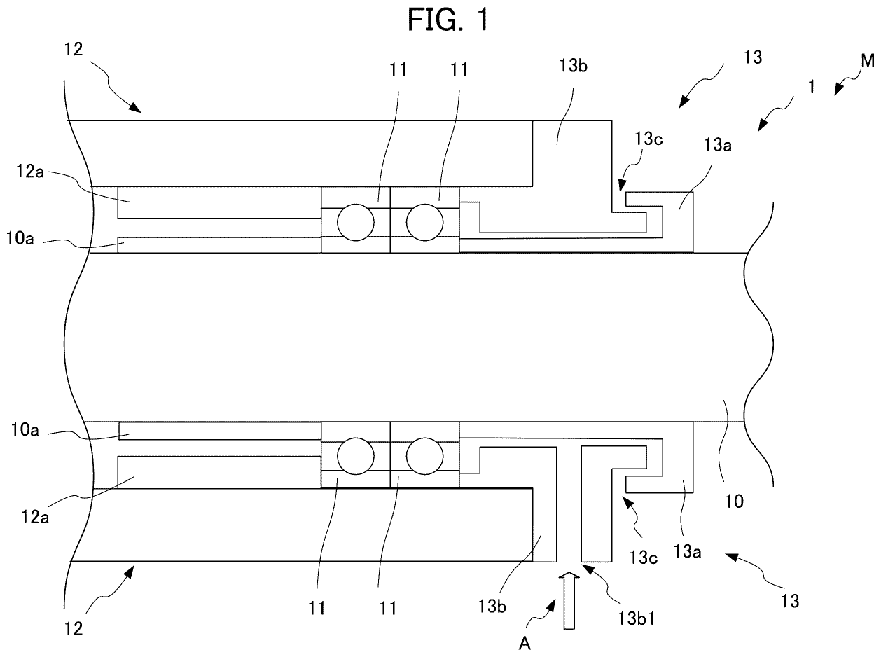

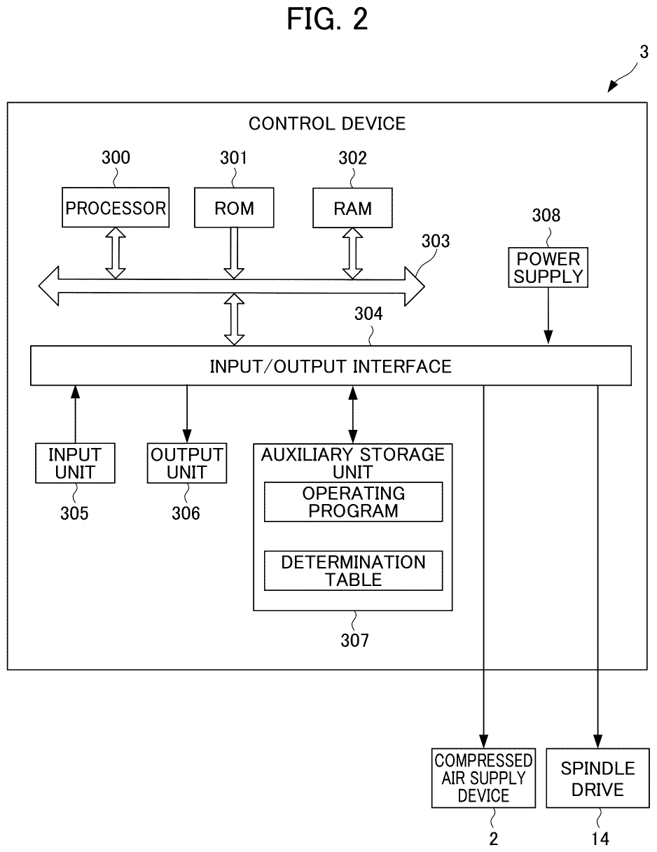

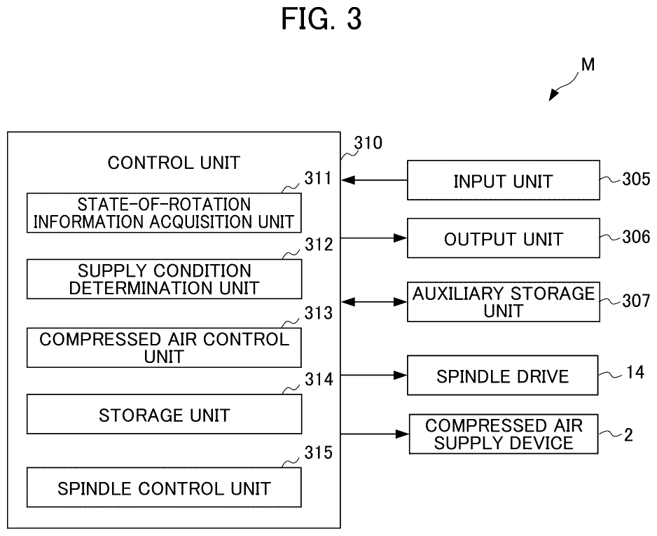

A configuration of a machine tool M according to the present embodiment will be described with reference to FIGS. 1 to 3. FIG. 1 is a schematic diagram illustrating an example of surroundings of a spindle 1 of the machine tool M according to the present embodiment. FIG. 2 is a block diagram illustrating a hardware configuration of a machine tool control device 3 according to the present embodiment. FIG. 3 is a block diagram for explaining a functional configuration of the machine tool control device 3 according to the present embodiment.

### <Machine Tool>

The machine tool M is a device having the spindle that rotationally drives a tool mounted thereto to thereby perform machining. The machine tool M includes the spindle 1, a compressed air supply device 2, and a machine tool control device 3.

The spindle 1 is a device that rotate to transmit power for the machine tool M to perform machining. The spindle 1 can be used in various machine tools. The details will be described later.

The compressed air supply device 2 is configured to supply compressed air to the interior of the spindle 1. The compressed air supply device 2 according to the present embodiment supplies compressed air to the interior of the spindle 1 via a labyrinth seal 13 (to be described later) functioning as a non-contact sealing structure. The compressed air supply device 2 is, for example, a pump. It should be noted that the compressed air supply device 2 is not limited to a pump. For example, it may be a common compressor for facilities installed throughout a factory.

The machine tool control device 3 is configured to control various operations of the machine tool M. The details will be described later.

### <Hardware Configuration of Surroundings of Spindle>

The configuration of the spindle 1 included in the machine tool M according to the present embodiment will be described with reference to FIGS. 1 to 3. As illustrated in FIG. 1, the spindle 1 includes a spindle shaft 10, a plurality of bearings 11, a housing 12, and a labyrinth seal 13 as a non-contact sealing structure. The spindle 1 is further provided with a spindle drive 14 illustrated in FIGS. 2 and 3.

The spindle shaft 10 is a solid cylindrical member for transmitting power from a drive to a machining part in the machine tool M. As illustrated in FIG. 1, the spindle shaft 10 has a stopper 10a fixed to an outer peripheral surface thereof. The stopper 10a is configured to restrict movement of the spindle shaft 10 relative to the housing 12 in the axial direction of the spindle shaft 10. The axial movement of the spindle shaft 10 is restricted by contact of the stopper 10a with the bearing 11 positioned inside the housing 12. The stopper 10a may be, for example, an annular member formed such that its inner peripheral surface is in contact with the outer peripheral surface of the spindle shaft 10. The stopper 10a is not limited in shape to the annular member.

The bearings 11 are configured to rotatably hold the spindle shaft 10. Each bearing 11 includes an outer ring, an inner ring, and a plurality of balls. The outer ring is fixed to the housing 12. The inner ring is fitted onto the spindle shaft 10 to make an interference fit therebetween and rotates relative to the outer ring. The plurality of balls are arranged in an annular shape orthogonal to the axial direction and are interposed between the outer ring and the inner ring, thereby enabling the inner ring to rotate relative to the outer ring. The thus-configured bearings 11 support the spindle shaft 10 with respect to the housing 12 and enable the spindle shaft 10 to rotate with respect to the housing 12.

The spindle 1 according to the present embodiment includes a total of four bearings 11 including two bearings 11 not shown, but this is a non-limiting example. The spindle 1 may include three or less bearings 11, or may include five or more bearings 11, for example.

The housing 12 is a hollow cylindrical member that is open at opposite ends thereof and is capable of accommodating the spindle shaft 10 and other components. The housing 12 accommodates the spindle shaft 10 and the bearings 11 therein such that the spindle shaft 10 protrudes from the openings of its hollow cylindrical body. As illustrated in FIG. 1, the housing 12 has a stopper 12a fixed to an inner peripheral surface thereof. The stopper 12a is configured to restrict movement of the bearings 11 relative to the housing 12 in the axial direction of the spindle shaft. The movement of the bearings 11 in the axial direction of the spindle shaft 10 is restricted by contact of the bearing 11 with the stopper 12a on the inner peripheral surface of the housing 12.

The labyrinth seal 13 is a non-contact sealing structure for suppressing intrusion by foreign matter and foreign liquid into the housing 12. Since the spindle 1 rotates at high speed, the labyrinth seal 13 as a non-contact sealing structure is employed in the machine tool M from the viewpoint of durability. The labyrinth seal 13 is provided so as to fill a space between each of openings at the opposite ends of the housing 12 and the spindle shaft 10. FIG. 1 illustrates one of the opposite ends of the housing 12 each provided with the labyrinth seal 13.

The labyrinth seal 13 includes an annular inner seal 13a fixed to the spindle shaft 10, and an annular outer seal 13b fixed to the housing 12, facing the inner seal 13a, and located adjacent to the housing 12 and outside of the inner seal 13a in a non-contact state.

The labyrinth seal 13 is configured to allow for air purge for supplying compressed air A to the interior of the spindle 1. Specifically, the labyrinth seal 13 has, in the outer seal 13b, an air purge portion 13b1 that is an air flow path through which the outside and inside of the labyrinth seal 13 communicate with each other, in order to supply the compressed air A to the inside of the labyrinth seal 13. The above-mentioned compressed air supply device 2 supplies the compressed air A to the interior of the spindle 1 through the air purge portion 13b1, whereby the air purge is performed. The labyrinth seal 13 further includes a labyrinth passage 13c that is a gap between the inner seal 13a and the outer seal 13b and serves as a flow path for air in the interior of the spindle to flow to the outside. Thus, the air in the interior of the spindle 1 leaks out from the labyrinth passage 13c. Therefore, performing the air purge causes the interior of the spindle 1 to be maintained at a positive pressure relative to outside air that is present outside the spindle 1 and contains cutting fluid mist. As a result, it is possible to cause the air in the interior of the spindle 1 to leak out from the labyrinth passage 13c, which is the gap in the labyrinth seal 13, and to prevent foreign matter such as dust and liquid from intruding through the gap.

The spindle drive 14 is configured to rotate the spindle shaft 10. The spindle drive 14 rotates the spindle shaft 10 by a motor (not shown), for example.

### <Hardware Configuration of Machine Tool Control Device>

Next, an example of a hardware configuration of the machine tool control device 3 according to one embodiment of the present invention will be described with reference to FIG. 2. As illustrated in FIG. 2, the machine tool control device 3 includes a processor 300, a read only memory (ROM) 301, a random access memory (RAM) 302, a bus 303, an input/output interface 304, an input unit 305, an output unit 306, an auxiliary storage unit 307, and a power supply 308.

The processor 300 is a central part of a computer for performing processing such as calculations and control necessary for the machine tool M to operate, and performs various calculations and processing. The processor 300 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), a field-programmable gate array (FPGA), or the like. Alternatively, the processor 300 is a combination of two or more of these. Alternatively, the processor 300 may be a combination of two or more of these and a hardware accelerator or the like.

The processor 300 controls the units to allow the machine tool control device 3 to perform various functions based on programs such as firmware, system software, and application software stored in the ROM 301 or the RAM 302. Further, the processor 300 performs processing based on the programs. It should be noted that part or all of the programs may be incorporated in a circuit of the processor 300.

The processor 300, the ROM 301, and the RAM 302 are connected to each other via the bus 303. The input/output interface 304 is also connected to this bus 303. The input unit 305, the output unit 306, the auxiliary storage unit 307, and the power supply 308 are connected to the input/output interface 304.

The input unit 305 and the output unit 306 are user interfaces electrically connected to the input/output interface 304 by wire or wirelessly. For example, the input unit 305 includes operation buttons and inputs various information in accordance with instruction operations by a user. The output unit 306 includes a display for displaying images and a speaker for loudening sound, and outputs images and sound. It should be noted that the input unit 305 according to the present embodiment functions as an operating condition input device that is used by an operator of the machine tool M. Thus, the machine tool M includes the input unit 305 for an operator to input an operating condition.

Here, the operating condition refer to information for operating the rotation of the spindle 1. For example, the operating condition is command information for rotating the spindle 1 at a predetermined rotational speed. In the present embodiment, the operating conditions are set for rotational speeds of three levels so that selection is allowed from the rotational speeds of three levels. Specifically, the operating conditions are set for the rotational speeds of three levels in a low-to-high order: a low speed, a medium speed, and a high speed. It should be noted that the operating information is not limited to this.

The operating condition may be information that commands a rotational acceleration when the spindle 1 is to be accelerated until it performs uniform speed rotation or a rotational acceleration when the spindle 1 is to be decelerated until it stops rotating. In this case, for example, the spindle 1 is accelerated or decelerated so that the spindle 1 undergoes the rotational acceleration specified by the operating condition inputted to the operating condition input device.

It should be noted that in the present embodiment, the input unit 305 also serves as the operating condition input device, but the present disclosure is not limited thereto. The operating condition input device may be provided separately from the input unit 305. In the present embodiment, the operating condition is acquired by way of input to the input unit 305 by the operator, but the present disclosure is not limited thereto. For example, the operating condition for the machine tool M may be acquired from an operating program stored in the auxiliary storage unit 307 described later.

The auxiliary storage unit 307 is an auxiliary storage device including a hard disk drive (HDD), a solid state drive (SSD), or the like. The auxiliary storage unit 307 stores various information such as programs and setting values related to various processing. The auxiliary storage unit 307 stores, for example, the operating condition (to be described later) inputted by the operator of the machine tool M, supply condition determination table information (to be described later) regarding compressed air supply conditions associated with the operating conditions, various programs, and the like.

The power supply 308 is connected to an external power source and is configured to supply power to the units of the machine tool control device 3. It should be noted that the configuration capable of supplying power to the power supply is not limited to this, and may be a battery, for example.

### <Functional Configuration of Machine Tool Control Device>

Next, a functional configuration of the machine tool control device 3 will be described with reference to FIG. 3. A control unit 310 that performs various controls for the machine tool control device 3 is implemented by the processor 300 (to be described later), which is capable of performing arithmetic processing, executing programs stored in the ROM 301, the RAM 302, the auxiliary storage unit 307, and the like.

The control unit 310 of the present embodiment includes a state-of-rotation information acquisition unit (state-of-rotation information acquisition function) 311, a supply condition determination unit (supply condition determination function) 312, a compressed air control unit (compressed air control function) 313, a storage unit (storage function) 314, and a spindle control unit (spindle control function) 315.

The state-of-rotation information acquisition unit 311 acquires state-of-rotation information indicating a state of rotation of the spindle 1. That is, the state-of-rotation information is information indicating a state of rotation of the spindle 1. The state-of-rotation information may include, for example, a state of a rotational speed of the spindle 1. Alternatively or additionally, the state-of-rotation information may include, for example, a state of a rotational acceleration of the spindle 1. The state-of-rotation information according to the present embodiment is the operating condition. That is, the state-of-rotation information acquisition unit 311 functions as an operating condition acquisition unit. In the present embodiment, because the spindle 1 operates in accordance with the operating condition, the operating condition can be utilized as the state-of-rotation information.

The supply condition determination unit 312 determines a supply condition based on the state-of-rotation information acquired by the state-of-rotation information acquisition unit 311. Specifically, the supply condition determination unit 312 of the present embodiment determines a supply condition necessary for compressed air that is to be supplied to the interior of the spindle 1, based on a state of rotation of the spindle 1 indicated by the operating condition acquired by the state-of-rotation information acquisition unit 311.

The supply condition is information necessary for compressed air that is to be supplied to the interior of the spindle 1. The supply condition according to the present embodiment is, for example, a pressure of compressed air that is to be supplied to the interior of the spindle 1. That is, the supply condition for compressed air determined by the supply condition determination unit 312 is the pressure of compressed air.

It should be noted that the supply condition may be, for example, a flow rate of compressed air that is to be supplied to the interior of the spindle 1. That is, the supply condition for compressed air determined by the supply condition determination unit 312 is a flow rate of compressed air.

In the present embodiment, different supply conditions are set for different states of rotation of the spindle 1. For example, as shown in Table 1 that is a supply condition determination table as related information, the supply conditions are associated with the operating conditions inputted to the input unit 305. Table 1 is an example of the supply condition determination table in which air pressures as the supply conditions are set in association with the operating conditions for the spindle. The pressure settings in Table 1 are in five levels from “0” at which no pressure is applied to “4” at which the pressure is maximum. It should be noted that the pressure settings are not limited to five levels, and may be in four levels or less or six levels or more. Further, the pressure settings are not limited to those shown in Table 1.

TABLE 1

| | Pressure |
|---|---|
| Condition | Setting |
| Spindle is accelerated or decelerated. | 4 |
| Spindle is rotating (rotational speed: low). | 4 |
| Spindle is rotating (rotational speed: medium). | 3 |
| Spindle is rotating (rotational speed: high). | 2 |
| Spindle is stationary immediately after being stopped. | 1 |
| Spindle has been stationary for a predetermined period | 0 |
| after being stopped. | |

For example, for the operating condition that the spindle 1 is accelerated or decelerated, the pressure is set to “4”, which is the maximum pressure. This is because, during acceleration or deceleration of the spindle 1, the internal pressure changes significantly due to centrifugal force acting in the interior of the spindle 1 so that there is a possibility that the interior of the spindle 1 decreases in pressure and cannot be maintained at a positive pressure. In the case where the interior of the spindle 1 decreases in pressure and cannot be maintained at a positive pressure, air does not sufficiently leak out from the labyrinth passage 13c which is a gap, and foreign matter and foreign liquid intrude. The foregoing setting raises the pressure of compressed air that is to be supplied to the interior of the spindle 1 and thereby reduces the likelihood that the interior of the spindle 1 decreases in pressure and cannot be maintained at a positive pressure.

For the operating condition that the spindle 1 is performing uniform high-speed rotation, the pressure is set to a lower value of “2”. This is because, during the uniform high-speed rotation of the spindle 1, even if the internal pressure is low, the air in the interior of the spindle 1 is pushed out to the outside of the spindle 1 by the effect of centrifugal force, and the air sufficiently leaks out from the labyrinth passage 13c which is the gap, thereby enabling prevention of intrusion by foreign matter and foreign liquid.

On the other hand, for the operating condition that the spindle 1 is performing uniform low-speed rotation, the pressure is set to a higher value of “4”. This is because, during the uniform low-speed rotation of the spindle 1, the influence of centrifugal force is small and the force pushing the air in the interior of the spindle 1 to the outside of the spindle 1 decreases. As a result, if the internal pressure is low, the air will not sufficiently leak out from the labyrinth passage 13c which is the gap, and foreign matter and foreign liquid will intrude. The foregoing setting raises the pressure of compressed air that is to be supplied to the interior of the spindle 1 and thereby reduces the likelihood that the interior of the spindle 1 decreases in pressure and cannot be maintained at a positive pressure. Therefore, the setting is made such that the internal pressure becomes higher during low-speed rotation than during high-speed rotation.

For the operating condition that the spindle 1 is performing uniform medium-speed rotation, the pressure is set to “3”, which is between the pressures set for the high-speed rotation and the low-speed rotation. This is because, during the uniform medium-speed rotation of the spindle 1, the influence of centrifugal force is about a half, which is between the influence of centrifugal force during the high-speed rotation and that during the low-speed rotation. Thus, by setting the pressure to be higher than that for the low-speed rotation and lower than that of the high-speed rotation, it is intended to reduce the consumption of compressed air, while preventing intrusion by foreign matter and foreign liquid.

For the operating condition that the spindle 1 is stationary immediately after being stopped, the pressure is set to a lower value of “1”. This is because, when the spindle 1 is stationary immediately after being stopped, it is presumed that the machine tool M is not performing machining, which means that the outside air contains a small amount of foreign matter and foreign liquid, and there is low risk of intrusion by the foreign matter and foreign liquid into the interior of the spindle 1.

For the operating condition that the spindle 1 has been stationary for a predetermined period after being stopped, the pressure is set to “0”. That is, in the case where the spindle 1 has been stationary for the predetermined period after being stopped, the air purge is stopped. This is because, in the case where the spindle 1 has been stationary for the predetermined period after being stopped, a concentration of mist including cutting fluid mist in the outside air decreases to a negligible level. The predetermined period is, for example, one minute. However, the predetermined period is not limited to one minute.

In accordance with the above-described supply condition determination table, the supply condition determination unit 312 determines the supply condition with a lower pressure as the rotational speed of the spindle 1 increases, and determines the supply condition with a higher pressure as the rotational speed of the spindle 1 decreases. The supply condition determination unit 312 determines the supply condition with a further lower pressure in the predetermined period immediately following a stop of the rotation of the spindle 1. The compressed air control unit 313 stops the operation of the compressed air supply device 2 upon a lapse of the predetermined period immediately following a stop of the rotation of the spindle 1.

It should be noted that in the present embodiment, the pressure of the compressed air to be supplied is set as the supply condition associated with the operating condition, but the present disclosure is not limited thereto. For example, a flow rate of the compressed air to be supplied may be set as the supply condition associated with the operating condition.

The compressed air control unit 313 controls the compressed air supply device 2 based on the supply condition determined by the supply condition determination unit 312. For example, the compressed air control unit 313 controls and causes the compressed air supply device 2 to supply compressed air at a pressure specified in the supply condition, to the interior of the spindle 1 via the labyrinth seal 13.

In order for the supply condition determination unit 312 to determine the supply condition, the storage unit 314 reads from the auxiliary storage unit 307 the supply condition determination table information, which is shown in Table 1 and is association information associating the operating conditions with the supply conditions, and stores the read information in the processor 300, ROM 301, RAM 302, and the like. Furthermore, in order for the supply condition determination unit 312 to determine the supply condition, the storage unit 314 provides the supply condition determination unit 312 with the supply condition determination table information that associates the operating conditions with the supply conditions.

The spindle control unit 315 drives the spindle drive 14 while controlling the rotation number of the spindle 1. For example, the spindle control unit 315 drives the spindle drive 14 while controlling the rotation number of the spindle 1 so that a rotational speed and a rotational acceleration according to the operating condition acquired by the state-of-rotation information acquisition unit 311 are achieved.

### <Compressed Air Supply Control>

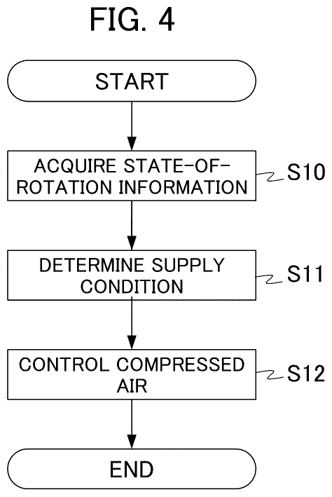

Next, compressed air supply control by the machine tool control device 3 according to the present embodiment will be described with reference to FIG. 4. FIG. 4 is a flowchart for explaining an example of the compressed air supply control by the machine tool control device according to the present embodiment. When the machine tool control device 3 of the present embodiment performs the compressed air supply control, the state-of-rotation information acquisition unit 311, the supply condition determination unit 312, the compressed air control unit 313, the storage unit 314, and the spindle control unit 315 perform the respective functions in the processor 300. The compressed air supply control is started at the timing when an operating condition is inputted to the input unit 305 by an operator of the machine tool M.

First, the state-of-rotation information acquisition unit 311 acquires, as state-of-rotation information, information regarding the operating condition inputted to the input unit 305 by the operator, or information regarding an operating condition from an operation program stored in the auxiliary storage unit 307 or the storage unit 314 and activated in conjunction with the operator's input to the input unit 305 (Step S10).

Next, the supply condition determination unit 312 determines a supply condition necessary for compressed air that is to be supplied to the interior of the spindle 1, based on the operating condition acquired by the state-of-rotation information acquisition unit 311 and the supply condition determination table information stored in the storage unit 314 and including a plurality of supply conditions for compressed air in association with operating conditions (Step S11).

Next, based on the supply condition determined by the supply condition determination unit 312, the compressed air control unit 313 controls the compressed air supply device 2 (Step S12). Specifically, the compressed air control unit 313 causes the compressed air supply device 2 to supply compressed air to the interior of the spindle 1 via the labyrinth seal 13 in accordance with the supply condition determined by the supply condition determination unit 312.

As described above, different pressures are required to suppress intrusion by foreign matter and foreign liquid into the spindle 1 for different states of rotation of the spindle shaft 10. In the machine tool M according to the present embodiment, the compressed air to be supplied to the spindle 1 can be set to a pressure appropriate to a state of rotation of the spindle shaft 10 of the spindle 1.

The machine tool control device 3 according to the present embodiment described above exerts the following effects. The spindle of the machine tool includes therein bearings to support high-speed rotation, and from the viewpoint of the life of the bearings, it is necessary to prevent foreign matter and foreign liquid from intruding into the interior of the spindle.

However, due to the capability of the spindle to rotate at high speed, it is impractical to use a seal having a contact portion. To address this, a non-contact sealing structure called a labyrinth seal is provided to the spindle, and the interior of the spindle is maintained at a positive pressure by air purge that introduces clean air into the interior of the spindle, thereby preventing intrusion by foreign matter and foreign liquid. Maintaining the interior of the spindle at a positive pressure requires use of compressed air, the generation of which requires a compressor.

The air purge is performed at a preset pressure regardless of operating conditions, and therefore, air may be consumed more than necessary depending on the operating conditions. A high consumption of air leads to an increase in energy consumption by the compressor.

According to the present embodiment, the air to be supplied to the interior of the spindle is controlled in accordance with a state of rotation of the spindle. Thus, air is consumed in the minimum amount required in the state of rotation of the spindle, whereby the air consumption is reduced in comparison with the conventional case, and power consumption in the entire factory can be reduced.

The machine tool control device 3 according to the present embodiment controls the machine tool M including the spindle 1 and the compressed air supply device 2 that supplies compressed air to the interior of the spindle 1. The machine tool control device 3 includes: the state-of-rotation information acquisition unit 311 that acquires state-of-rotation information indicating a state of rotation of the spindle 1; the supply condition determination unit 312 that determines a supply condition necessary for compressed air that is to be supplied to the interior of the spindle 1, based on the state-of-rotation information acquired by the state-of-rotation information acquisition unit 311; and the compressed air control unit 313 that controls the compressed air supply device 2 based on the supply condition determined by the supply condition determination unit 312.

This configuration makes it possible to suppress the consumption of compressed air supplied to the interior of the spindle 1.

According to the machine tool control device 3 of the present embodiment, the machine tool M includes the input unit 305 for an operator to input an operating condition, the state-of-rotation information acquisition unit 311 acquires the operating condition inputted by the operator as the state-of-rotation information, and the supply condition determination unit 312 determines a supply condition necessary for compressed air that is to be supplied to the interior of the spindle 1, based on the state of rotation of the spindle 1 indicated by the operating condition acquired by the state-of-rotation information acquisition unit 311.

Due to this configuration, the operating condition inputted by the operator can be utilized as the state-of-rotation information regarding the spindle 1, thereby making it possible to suppress the consumption of compressed air while facilitating the control.

The machine tool control device 3 according to the present embodiment further includes the storage unit 314 that stores supply condition determination table information that associates the operating conditions with the supply conditions, and the supply condition determination unit 312 determines a supply condition based on the operating condition inputted to the input unit 305 and the supply condition determination table information stored in the storage unit 314.

Due to this configuration, the supply condition can be determined according to the table in which the operating conditions and the supply conditions are associated with each other, thereby making it possible to suppress the consumption of compressed air while facilitating the control.

According to the machine tool control device 3 of the present embodiment, the state of rotation of the spindle 1 includes a state of a rotational speed of the spindle 1.

Due to this configuration, information regarding the rotational speed can be utilized as the state-of-rotation information, thereby making it possible to suppress the consumption of compressed air while facilitating the control.

According to the machine tool control device 3 of the present embodiment, the state of rotation of the spindle 1 includes a state of a rotational acceleration of the spindle 1.

Due to this configuration, information regarding the rotational acceleration can be utilized as the state-of-rotation information, thereby making it possible to suppress the consumption of compressed air while facilitating the control.

According to the machine tool control device 3 of the present embodiment, the supply condition for the compressed air determined by the supply condition determination unit 312 is a pressure of the compressed air.

Due to this configuration, information indicating a supply pressure at which the compressed air is to be supplied by the compressed air supply device 2 can be utilized as it is as the supply condition, thereby making it possible to facilitate the control and suppress the consumption of compressed air.

According to the machine tool control device 3 of the present embodiment, the supply condition for the compressed air determined by the supply condition determination unit 312 is a flow rate of the compressed air.

Due to this configuration, the information indicating a supply flow rate at which the compressed air is to be supplied by the compressed air supply device 2 can be utilized as it is as the supply condition, thereby making it possible to more easily suppress the consumption of compressed air.

According to the machine tool control device 3 of the present embodiment, the supply condition determination unit 312 determines the supply condition with a higher pressure as the rotational speed of the spindle 1 decreases, and determines the supply condition with a lower pressure as the rotational speed of the spindle 1 increases.

Due to this configuration, the pressure of compressed air can be reduced by the magnitude of a pressure that becomes unnecessary due to centrifugal force applied to the air in the interior of the spindle 1 by rotation of the spindle 1, thereby making it possible to further easily suppress the consumption of compressed air.

According to the machine tool control device 3 of the present embodiment, the supply condition determination unit 312 determines the supply condition with a lower pressure for a predetermined period immediately following a stop of the rotation of the spindle 1, and the compressed air control unit 313 stops operation of the compressed air supply device 2 after a lapse of the predetermined period immediately following the stop of the rotation of the spindle 1.

Due to this configuration, in a case where it is presumed that machining is not being performed immediately after a stop of the spindle 1 and the outside air contains a small amount of foreign matter and foreign liquid, unnecessary consumption of compressed air is avoided. Further, in a case where the spindle 1 has been stationary for the predetermined period after being stopped and a concentration of mist including cutting fluid mist in the outside air decreases to a negligible level, unnecessary consumption of compressed air is avoided. Therefore, consumption of compressed air can be suppressed more easily.

### Modification

In the embodiment described above, the supply condition determination unit 312 determines the supply condition necessary for the compressed air that is to be supplied to the interior of the spindle 1, based on the operating condition inputted to the input unit 305 by the operator of the machine tool M as the state-of-rotation information regarding the spindle 1, but this is a non-limiting example. For example, in a case where the machine tool M further includes measurement equipment 15 (to be described later) capable of measuring a state of rotation of the spindle 1, the state-of-rotation information acquisition unit 311 may acquire measurement result information indicating the state of rotation of the spindle 1 measured by the measurement equipment 15 as the state-of-rotation information regarding the spindle 1. The supply condition determination unit 312 may determine the supply condition necessary for the compressed air that is to be supplied to the interior of the spindle 1, based on the measurement result information acquired by the state-of-rotation information acquisition unit 311.

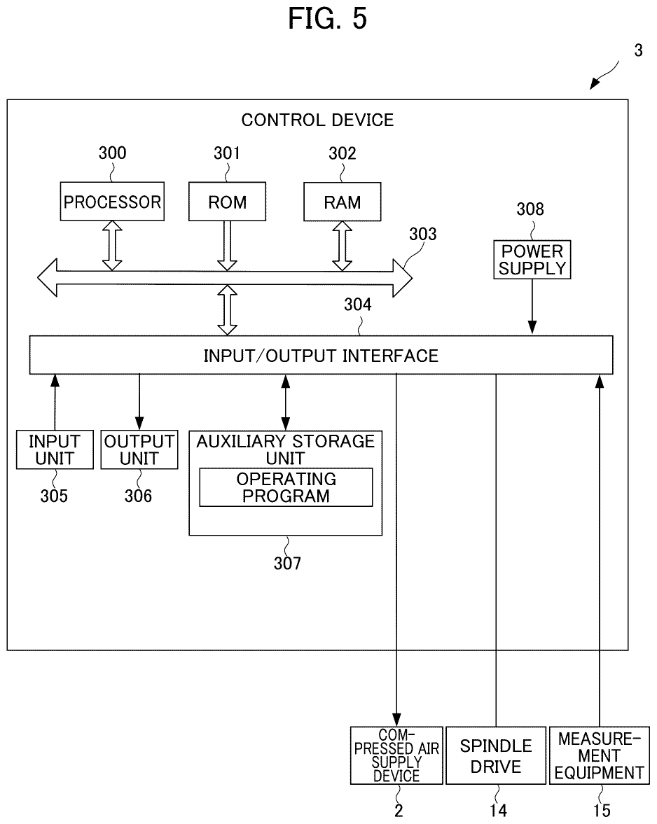

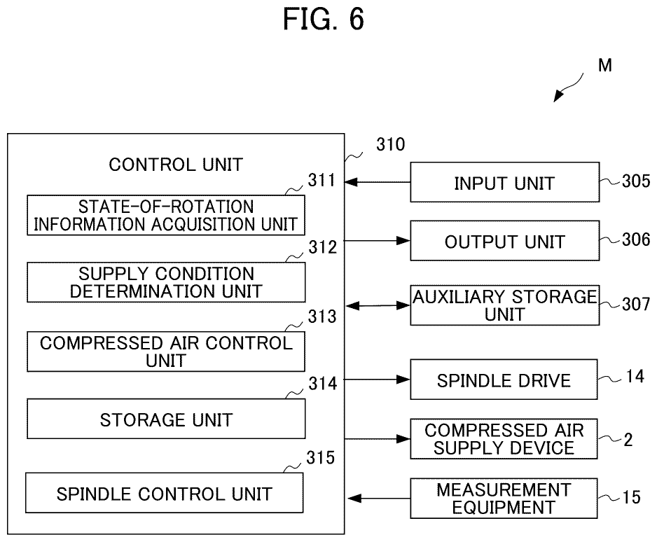

The following describes a machine tool M according to the above modification with reference to FIG. 1 and FIGS. 4 to 6. FIG. 5 is a block diagram illustrating a hardware configuration of a machine tool control device 3 according to the modification. FIG. 6 is a block diagram for explaining a functional configuration of the machine tool control device 3 according to the modification. Components similar to those in the embodiment described above are denoted by the same appellations and a detailed description thereof may be omitted.

### <Machine Tool>

The machine tool M is a device having a spindle that rotationally drives a tool mounted thereto to thereby perform machining. The machine tool M includes the spindle 1, a compressed air supply device 2, and a machine tool control device 3.

### <Hardware Configuration of Surroundings of Spindle>

As illustrated in FIG. 1, the spindle 1 includes a spindle shaft 10, a plurality of bearings 11, a housing 12, and a labyrinth seal 13 as a non-contact sealing structure. The spindle 1 is further provided with a spindle drive 14 and measurement equipment 15 illustrated in FIGS. 5 and 6.

The measurement equipment 15 is configured to measure a state of rotation of the spindle shaft 10. In other words, the machine tool M further includes the measurement equipment 15 capable of measuring a state of rotation of the spindle 1. The measurement equipment 15 is constituted of, for example, a rotary encoder capable of measuring a rotation number, and can measure a rotational speed of the spindle shaft 10. The measurement equipment 15 may also be capable of measuring an acceleration based on the rotation number of the spindle shaft 10.

### <Hardware Configuration of Machine Tool Control Device>

Next, an example of a hardware configuration of the machine tool control device 3 according to the present modification will be described with reference to FIG. 5. As illustrated in FIG. 5, the machine tool control device 3 includes a processor 300, a ROM 301, a RAM 302, a bus 303, an input/output interface 304, an input unit 305, an output unit 306, an auxiliary storage unit 307, and a power supply 308.

### <Functional Configuration of Machine Tool Control Device>

Next, the functional configuration of the machine tool control device 3 will be described with reference to FIG. 6. The control unit 310 of the present modification includes a state-of-rotation information acquisition unit (state-of-rotation information acquisition function) 311, a supply condition determination unit (supply condition determination function) 312, a compressed air control unit (compressed air control function) 313, a storage unit (storage function) 314, and a spindle control unit (spindle control function) 315.

The state-of-rotation information acquisition unit 311 acquires state-of-rotation information indicating a state of rotation of the spindle 1. For example, the state-of-rotation information acquisition unit 311 according to the present modification acquires measurement result information indicating a state of rotation of the spindle 1 measured by the measurement equipment 15.

The supply condition determination unit 312 determines a supply condition based on the state-of-rotation information acquired by the state-of-rotation information acquisition unit 311. For example, the supply condition determination unit 312 according to the present modification determines a supply condition necessary for compressed air that is to be supplied to the interior of the spindle 1, based on the measurement result information acquired by the state-of-rotation information acquisition unit 311.

For example, for the above-described supply condition determination table information in Table 1, thresholds may be set in advance for the low speed, medium speed, and high speed and stored in the auxiliary storage unit 307 or the storage unit 314. The supply condition determination unit 312 may compare the rotational speed measured by the measurement equipment 15 with the stored thresholds to identify the operating condition, and determine a supply condition based on the identified operating condition and the supply condition determination table information. The supply condition determination unit 312 can also calculate and determine a supply condition based on the measured rotational speed. For example, the determined supply condition may include either one of a pressure setting and a flow rate setting that are inversely proportional to the measured rotational speed.

### <Compressed Air Supply Control>

Next, compressed air supply control by the machine tool control device 3 according to the present modification will be described with reference to FIG. 4. When the machine tool control device 3 according to the present modification performs the compressed air supply control, the state-of-rotation information acquisition unit 311, the supply condition determination unit 312, the compressed air control unit 313, the storage unit 314, and the spindle control unit 315 perform the respective functions in the processor 300. The compressed air supply control is started at the timing when an operating condition is inputted to the input unit 305 by an operator of the machine tool M.

First, the state-of-rotation information acquisition unit 311 acquires measurement result information measured by the measurement equipment 15 as the state-of-rotation information regarding the spindle 1 (Step S10).

Next, the supply condition determination unit 312 determines a supply condition necessary for compressed air that is to be supplied to the interior of the spindle 1, based on the measurement result information acquired by the state-of-rotation information acquisition unit 311 (Step S11).

Next, based on the supply condition determined by the supply condition determination unit 312, the compressed air control unit 313 controls the compressed air supply device 2 (Step S12). Specifically, the compressed air control unit 313 causes the compressed air supply device 2 to supply compressed air to the interior of the spindle 1 via the labyrinth seal 13 in accordance with the supply condition determined by the supply condition determination unit 312.

As described above, different pressures are required to suppress intrusion by foreign matter and foreign liquid into the spindle 1 for different states of rotation of the spindle shaft 10. In the machine tool M according to the present embodiment, the compressed air to be supplied to the spindle 1 can be set to a pressure appropriate to a state of rotation of the spindle shaft 10 of the spindle 1.

The machine tool control device 3 according to the modification described above exerts the following effects. According to the machine tool control device 3 of the present modification, the machine tool M further includes the measurement equipment 15 capable of measuring a state of rotation of the spindle 1. The state-of-rotation information acquisition unit 311 acquires measurement result information indicating a state of rotation of the spindle 1 measured by the measurement equipment 15 as the state-of-rotation information, and the supply condition determination unit 312 determines a supply condition necessary for the compressed air that is to be supplied to the interior of the spindle 1, based on the measurement result information acquired by the state-of-rotation information acquisition unit 311.

Due to this configuration, a supply information necessary for the compressed air that is to be supplied to the interior of the spindle 1 can be set for a more detailed state of rotation of the spindle 1 based on the measurement result, thereby making it possible to further suppressing consumption of compressed air.

The series of processing according to the above-described method can be executed by hardware or by software. In other words, the functional configurations illustrated in FIGS. 3 and 6 are merely examples, and no particularly limitation is imposed. Specifically, it is simply required to have a function of executing the above-described series of processing as a whole, and the functional blocks used to fulfil this function are not particularly limited to the examples illustrated in FIGS. 3 and 6.

One functional block may be constituted of hardware alone, software alone, or a combination thereof. The functional configuration of the present embodiment is implemented by a processor that executes arithmetic processing, and examples of the processor that can be used in the present embodiment include a processor constituted of one of various processing devices alone such as a single processor, a multiprocessor, and a multi-core processor, and a processor in which one or more of the various processing devices are combined with a processing circuit such as an application specific integrated circuit (ASIC) or a field-programmable gate array (FPGA).

In a case where the series of processing is executed by software, a program constituting the software is installed in a computer or the like from a network or a recording medium. The computer may be a computer incorporated in dedicated hardware. Alternatively, the computer may be a computer capable of performing various functions by installing various programs, for example, a general-purpose personal computer.

Example of a recording medium containing such a program include not only a removable medium distributed separately from the device body in order to provide the program to a user, but also a recording medium or the like incorporated in advance in the device body and provided to a user. Examples of the removable medium include a magnetic disk (including a floppy disk), an optical disk, a magneto-optical disk, and the like. Examples of the optical disk include a compact disk-read only memory (CD-ROM), a digital versatile disk (DVD), a Blu-ray (registered trademark) disc, and the like. Examples of the magneto-optical disk include a Mini-Disk (MD) and the like. Examples of the recording medium incorporated in advance in a device body and provided to a user include the ROM on which a program is recorded and illustrated in FIGS. 2 and 5, a hard disk included in the auxiliary storage unit illustrated in FIGS. 2 and 5, and the like.

It should be noted that in the present specification, steps of describing a program to be recorded on a recording medium include not only processes that are executed in time sequence in the order, but also processes that are executed in parallel or individually and not necessarily in time sequence.

Although several embodiments of the present invention have been described above, the embodiments are merely examples and are not intended to limit the technical scope of the present invention. The present invention can be implemented in various other embodiments, and furthermore, various modifications such as omissions and substitutions can be made without deviating from the spirit of the present invention. Such embodiments and modifications thereof are encompassed in the scope and spirit of the invention described in the present specification and other documents pertaining thereto, and are encompassed in the invention described in the claims and equivalents thereof.

The following further discloses additional remarks regarding the foregoing embodiments and the modifications.

### (Additional Remark 1)

A machine tool control device for controlling a machine tool including a spindle and a compressed air supply device that supplies compressed air to an interior of the spindle, the machine tool control device includes:
a state-of-rotation information acquisition unit that acquires state-of-rotation information indicating a state of rotation of the spindle;
a supply condition determination unit that determines a supply condition necessary for compressed air that is to be supplied to the interior of the spindle, based on the state-of-rotation information acquired by the state-of-rotation information acquisition unit; and
a compressed air control unit that controls the compressed air supply device based on the supply condition determined by the supply condition determination unit.

### (Additional Remark 2)

According to the machine tool control device of Additional Remark 1,
the machine tool includes an operation input unit for an operator to input an operating condition,
the state-of-rotation information acquisition unit acquires the operating condition inputted by the operator as the state-of-rotation information, and
the supply condition determination unit determines the supply condition necessary for compressed air that is to be supplied to the interior of the spindle, based on a state of rotation of the spindle indicated by the operating condition acquired by the state-of-rotation information acquisition unit.

### (Additional Remark 3)

The machine tool control device according to Additional Remark 2 further includes a storage unit that stores association information that associates the operating condition with the supply condition, and the supply condition determination unit determines the supply condition based on the operating condition inputted to the operation input unit and the association information stored in the storage unit.

### (Additional Remark 4)

According to the machine tool control device of Additional Remark 1,
the machine tool further includes measurement equipment capable of measuring a state of rotation of the spindle,
the state-of-rotation information acquisition unit acquires measurement result information indicating the state of rotation of the spindle measured by the measurement equipment as the state-of-rotation information, and
the supply condition determination unit determines the supply condition necessary for compressed air that is to be supplied to the interior of the spindle, based on the measurement result information acquired by the state-of-rotation information acquisition unit.

### (Additional Remark 5)

According to the machine tool control device of any one of Additional Remarks 1 to 4, the state of rotation of the spindle includes a state of a rotational speed of the spindle.

### (Additional Remark 6)

According to the machine tool control device of any one of Additional Remarks 1 to 5, the state of rotation of the spindle includes a state of a rotational acceleration of the spindle.

### (Additional Remark 7)

According to the machine tool control device of any one of Additional Remarks 1 to 6, the supply condition for compressed air determined by the supply condition determination unit is a pressure of compressed air.

### (Additional Remark 8)

According to the machine tool control device according of any one of Additional Remarks 1 to 7, the supply condition for compressed air determined by the supply condition determination unit is a flow rate of compressed air.

### (Additional Remark 9)

According to the machine tool control device of any one of Additional Remarks 5 to 7, the supply condition determination unit determines the supply condition with a lower pressure as the rotational speed of the spindle increases, and determines the supply condition with a higher pressure as the rotational speed of the spindle decreases.

### (Additional Remark 10)

According to the machine tool control device of Additional Remark 9,
the supply condition determination unit determines the supply condition with a lower pressure for a predetermined period immediately following a stop of rotation of the spindle, and
the compressed air control unit stops operation of the compressed air supply device after a lapse of the predetermined period immediately following the stop of the rotation of the spindle.
M: Machine tool
1: Spindle
2: Compressed air supply device
3: Machine tool control device
311: State-of-rotation information acquisition unit
312: Supply condition determination unit
313: Compressed air control unit

1. A machine tool control device for controlling a machine tool including a spindle and a compressed air supply device that supplies compressed air to an interior of the spindle, the machine tool control device comprising:
a state-of-rotation information acquisition unit that acquires state-of-rotation information indicating a state of rotation of the spindle;
a supply condition determination unit that determines a supply condition necessary for compressed air that is to be supplied to the interior of the spindle, based on the state-of-rotation information acquired by the state-of-rotation information acquisition unit; and
a compressed air control unit that controls the compressed air supply device based on the supply condition determined by the supply condition determination unit.

2. The machine tool control device according to claim 1, wherein
the machine tool includes an operation input unit for an operator to input an operating condition,
the state-of-rotation information acquisition unit acquires the operating condition inputted by the operator as the state-of-rotation information, and
the supply condition determination unit determines the supply condition necessary for compressed air that is to be supplied to the interior of the spindle, based on a state of rotation of the spindle indicated by the operating condition acquired by the state-of-rotation information acquisition unit.

3. The machine tool control device according to claim 2, further comprising:
a storage unit that stores association information that associates the operating condition with the supply condition, wherein
the supply condition determination unit determines the supply condition based on the operating condition inputted to the operation input unit and the association information stored in the storage unit.

4. The machine tool control device according to claim 1, wherein
the machine tool further includes measurement equipment capable of measuring a state of rotation of the spindle,
the state-of-rotation information acquisition unit acquires measurement result information indicating the state of rotation of the spindle measured by the measurement equipment as the state-of-rotation information, and
the supply condition determination unit determines the supply condition necessary for compressed air that is to be supplied to the interior of the spindle, based on the measurement result information acquired by the state-of-rotation information acquisition unit.

5. The machine tool control device according to claim 1, wherein the state of rotation of the spindle includes a state of a rotational speed of the spindle.

6. The machine tool control device according to claim 1, wherein the state of rotation of the spindle includes a state of a rotational acceleration of the spindle.

7. The machine tool control device according to claim 1, wherein the supply condition for compressed air determined by the supply condition determination unit is a pressure of compressed air.

8. The machine tool control device according to claim 1, wherein the supply condition for compressed air determined by the supply condition determination unit is a flow rate of compressed air.

9. The machine tool control device according to claim 5, wherein
the supply condition determination unit determines the supply condition with a lower pressure as the rotational speed of the spindle increases, and determines the supply condition with a higher pressure as the rotational speed of the spindle decreases.

10. The machine tool control device according to claim 9, wherein
the supply condition determination unit determines the supply condition with a lower pressure for a predetermined period immediately following a stop of rotation of the spindle, and
the compressed air control unit stops operation of the compressed air supply device after a lapse of the predetermined period immediately following the stop of the rotation of the spindle.
